(19) United States
(12) Patent Application Publication
(10) Pub. No.: US 2002/0021439 A1
(43) Pub. Date: Feb. 21, 2002

(54) Colour matching system

(76) Inventors: Derek Priestley, Brighouse West Yorkshire (GB); Stephen Martin Burkinshaw, Collingham (GB); Malcolm Gill, Hollywell Green (GB); Brian Nattress, Guiseley (GB)

Correspondence Address: MYERS BIGEL SIBLEY & SAJOVEC, PO BOX 37428, RALEIGH, NC, 27627, US

(21) Appl. No.: 09/922,823

(22) Filed: Aug. 6, 2001

Related U.S. Application Data
(60) Provisional application No. 60/255,461, filed on Dec. 13, 2000.
(60) Provisional application No. 60/288,592, filed on May 3, 2001.

(30) Foreign Application Priority Data
Aug. 7, 2000 (GB) GB0019297.1
Nov. 3, 2000 (GB) GB0027021.5
Feb. 13, 2001 (GB) GB0103453.7
Apr. 26, 2001 (GB) GB0110197.1
Apr. 26, 2001 (GB) GB0113947.6

(51) Int. Cl. G01J 3/52

(52) U.S. Cl. 356/243.5; 356/421

(57) ABSTRACT

A system for, and method of, color matching and/or identifying color parameters of articles such as teeth, textiles, paints, dyes, car body repairs, picture restoration, metals and gems and for use in the cosmetics industry. The system comprises means for taking a colored image of an object, means for relaying the colored image to a place remote from where the image of the object was taken, means for analysing color values of the image and means for converting the color values into parameters from which the original color of the object can be reconstituted or color parameters may be cross-referenced and/or recorded over time.

The present invention relates to a system for, and method of, colour matching, for particular, but not exclusive, use in the colour matching of articles such as teeth, textiles, paints, dyes, car body repairs, picture restoration and in the cosmetics industry. In addition, the present invention relates to a system for, and method of, colour identification, for particular, but not exclusive, use in the colour identification of the colours of precious metals, gems and stones and for use in the printing and security industries.

### BACKGROUND OF THE INVENTION

It is known from the prior art to colour match a variety of objects simply by eye and to compare the colour with a reference colour guide. The colour guide is usually held in proximity to the test object for a direct comparison. This is a purely subjective evaluation and can lead to a colour mismatch since one person's assessment may differ from another's. Moreover, the perception of colour is dependent on a number of factors such as the background lighting conditions and texture of the object itself. An object with a pitted surface may, if viewed in one direction, cast shadows on its own surface thus distorting the overall colour of the object. Alternatively, a smooth shiny object can reflect light from its surface leading to bright spots similar colour distortions.

In the restoration or replacement of a tooth or set of teeth, it is important accurately to select the correct tooth colour so as to match, not only the adjacent tooth in colour and shape, but to match the entire set of teeth in overall colour harmony and surface contour profile. However, it is difficult to critically assess highly reflective surfaces such as the enamel of teeth. It is known from the prior art to quantify the colour of teeth by manually comparing a patient's natural teeth with a set of “shade guides”. These guides typically comprise a row of substantially flat, plastic tooth shaped items mounted on a board in ascending grades of shades. The first step in the colour determination process is made subjectively by the dentist or dental technician, by holding the shade guide next to the patient's own natural teeth and attempting to find the best match. This can be problematic because tooth colour is affected not only by ambient light colour/intensity in the surgery i.e. fluorescent or natural light, but also by the surrounding colour of the patient's own clothing or make-up/complexion. In addition this step is dependent on the visual acuity and experience of the dentist or dental technician.

Once the dentist or dental technician has made his/her choice of best match colour from the shade guide the next step in the process is to relay the information to a dental laboratory technician who then constructs the dental prosthesis, typically from a set of pre-coloured components. The information he/she may receive is that the dental prosthesis required is a mix between two of the shades on the guide. In this step of the overall process, there is a dependency on a yet further subjective colour assessment by the dental laboratory technician when mixing appropriate ratios of the pre-coloured components to the specified recipe. Once constructed, the finished product is then returned to the dentist for fitting into a patient's mouth. It is only after the dental prosthesis has been constructed that it becomes apparent if the colour match was accurately evaluated by the dentist or dental technician and subsequently constructed by the dental laboratory technician. It will be appreciated this process often results in unacceptable levels of colour mismatching so that a second or replacement dental prosthesis needs to be constructed at a substantial cost and inconvenience to the patient, dental professional and dental prosthesis manufacturer.

Methods which have been attempted to try to minimise human error when assessing tooth colour include:

illuminating the patient's mouth in a controlled manner and comparing the natural teeth to a reference shade guide set illuminated under similar conditions. The problem with this method is that it does not completely eliminate variations in ambient lighting conditions.

photographing the patient's mouth with a reference shade guide in the frame. The problem with this method is that the equipment can be bulky and that the colour in the photograph may be distorted and/or misrepresented through the process of developing and producing the photograph. In addition, the flash from the camera causes high levels of reflection from the tooth surface.

videoing the patient's mouth with a reference shade guide in the frame. The problem with this method is that the equipment can be bulky and that the colour in the video may not be accurate. Moreover, the video cameras are intra-oral and so careful hygiene procedures have to be adopted which can be time consuming and may not even be completely effective.

manually drawing and painting/colouring an artist's impression of a tooth. The problem with this is that it can be expensive, time consuming, and it is not independent of ambient lighting conditions.

None of the prior art methods are capable of capturing an exact colour image of a natural tooth. This is partly because of the inherent properties of teeth themselves. Natural teeth are curved, not uniformly smooth and the colour distribution of the tooth is not even or uniformly distributed throughout the tooth. Natural teeth are translucent on their surface, the transparencies of dentine and enamel are difficult to correct for when representing the colour of a tooth. Teeth are light reflective which results in bright spots and bright lines. All of these factors contribute to the difficulty in accurately capturing a colour image of a tooth.

A problem not addressed by any of the prior art methods is the subjective colour assessment which the dental laboratory technician has to make when given a recipe or image to work to, so as to construct the dental prosthesis. Some methods have made improvements in the standardisation of assessing the colour of the patient's tooth in the first instance, but problems remain with human errors in constructing and colour matching the prosthesis to a recipe.

A method of accurate colour image capture which is non-invasive, and construction of a prosthesis to that colour would offer immediate advantage over the prior art.

### STATEMENT OF INVENTION

In its broadest aspect the present invention provides a system for, and method of, colour matching and/or colour identification of an object by capturing a colour image and communication, processing, display and manipulation thereof.

According to a first aspect of the invention there is provided a system for colour matching an object comprising:

(i) means for taking a coloured image of an object;

(ii) means for relaying the coloured image to a place remote from a location where the image of the object was taken;

(iii) means for analysing colour values of the image; and

(iv) means for converting the colour values into parameters from which the original colour of the object can be reconstituted.

Preferably, the means for taking a coloured image of the object is a camera, and more preferably it is a digital camera.

Preferably, the camera is provided with cross-polarised filtration. Typically this is achieved by a pair of cross-polarised filters, preferably the filters are grey so as provide a minimal colour temperature shift whilst simultaneously providing good transmission. The effect of cross-polarised photography is to control reflections, lustre and to cut out glare.

Preferably, the camera is pre-set and/or pre-programmed to a specified focal length. For example, the focal length may be 25±2 cm. It is desirable to try to reduce any deviations in focal length so as to minimise errors that may occur by virtue of variations in, or non-uniform, illumination.

Preferably, the system further includes a camera housing assembly for supporting the camera.

Preferably, the camera housing assembly is provided with a light source for illuminating the object. Typically, medical grade light is transmitted to the assembly via a fibre optic cable. The light source comprises, for example, a plurality of light spots arranged in a ring. It will be appreciated that the fibre optic cable can be divided/split so as to produce individual lights spots. A typical light source comprises 12 light spots arranged in a ring which focus at, for example, 25±2 cm from the object which is to be imaged. However, as few as 4 light spots and up to 24 light spots are usually provided. The light spots act to provide a quantifiable field of light and as such their number is not intended to limit the scope of the application.

Preferably, the camera housing assembly further comprises a telescopic member for preventing incidental light entering the field of shot.

Preferably, the telescopic member comprises a tube. Preferably, the tube comprises two independently extendible lengths associated along their longitudinal axes. In one embodiment the associated lengths comprise longitudinal tube halves (i.e. notionally formed by dividing the tube lengthwise across its diameter) whose longitudinal edges slidingly engage and which may be adjusted so that, in use, and when extended, the tube can be made to conform approximately to the shape of curved objects and to rest thereagainst by extending one half of the tube more than the other half. This arrangement is of particular advantage when taking images of a patient's teeth that are not in a central position in the mouth. In use, the tube is extended prior to taking of the image and may be retracted when not in use.

Preferably, the camera housing assembly further comprises means for assessing distance between the camera and the object to be imaged. In one embodiment, the means for assessing the distance comprises a cross-hair arrangement, the cross-hairs preferably being mutually perpendicular, for example horizontal and vertical, which when correctly aligned indicates to a user that the correct distance between the camera lens and object has been achieved. Alternatively, a pair of right and left light beams or lasers may be used so that when the right and left beams meet at a common point the user knows that the correct distance has been reached.

It will be appreciated that the system of the present invention advantageously provides a quantifiable and controllable light source, in addition to quantifiable and controllable distance from camera to object and pre-determined camera settings so that accurate and reproducible images of an object can be obtained.

Preferably, the system further includes a reference colour indicator placed in close proximity to the object or associated with the camera's visual field so that the captured image contains a reference colour.

Preferably, the reference colour is grey and more preferably still the grey is cool grey C pantone number 8. The reference indicator may take the form of a substantially U or L shaped block and in an alternative embodiment the reference indicator may be in the form of a sheet or paper. In this particular embodiment the reference indicator is provided as paper with an adhesive side so that it may be attached to the substantially U or L shaped blocks. It is envisaged that the reference indicator paper will be supplied in roll form so that the outer layer protects underlying layers and acts to preserve the colour by protecting it from light and/or mechanical damage. The reference indicator may also be labelled so that the image of the object can easily be identified or cross referenced.

Preferably, the means for relaying the captured image to a place remote from where the image was captured is an electronic communication means such as the Internet or a dedicated telephone line or may be a data carrier such as a disc or CD-ROM or the like.

Preferably, in the instance of relaying image data via the Internet the data is encrypted so that whilst it is in the public domain or “on air” it is in a form that cannot be accessed by the public. It will be appreciated that some information, especially that relating to medical and/or dental records, is confidential information between a patient and health professional(s).

Preferably, the means for analysing the colour values is a computer software program which is capable of converting the cross-polarised image of the original object into a plurality of single colour images.

The tooth is divided into several areas of similar colour value, each of which is assigned a unique bright colour key thus making them more distinguishable to the eye. The analysis proceeds to determine both the average and the most dominant colour value in each area. The colour values are represented by the intensity of red, green and blue components of that value.

Preferably, the colour values of the captured image of the original object colour are represented by intensities of red, blue and green colour components. Thus, three colour components (for red, blue and green) are generated from the constituents of the colour values of the original image.

The software program is preferably also capable of converting the single colour images into parameters from which the original colour of the object can be reconstituted. The program preferably contains a database of predetermined colour attributes.

In use, the system allows a user to take a photograph of an object, for example a piece of coloured textile and to relay information relating to the photograph to a place remote from where the textile actually is, for example a paint factory. An operator in the paint factory then initiates the software program to analyse the colour values from which a recipe can be generated so that a replica of the colour of the textile can be reconstituted from various ratios of different dyes.

Preferably, the system is for colour matching a natural tooth or set of teeth so that a dental prosthesis can be constructed to match the natural tooth of a patient.

Reference herein to a dental prosthesis is intended to include crowns, dentures, caps and any other dental product which is intended to replace or form part of a patient's set of teeth.

In this embodiment of the invention the system provides means for capturing an image of a natural tooth, means for relaying the image of the tooth to a dental laboratory, means for analysing colour values of the image of the tooth and means for converting the colour values of the tooth into parameters from which a dental prosthesis colour matching the colour attributes of the patient's natural tooth can be made.

The database of predetermined colour attributes will generally contain fewer discrete attributes than are present within the true-colour digital image. In a particularly preferred application of the present invention, which is to generate dental prostheses from ceramics or the like of known colours so as closely to match a patient's natural tooth colours, the database will contain the colour attributes of a range of available ceramics materials or the like. The database may contain several subsets of ceramics colours corresponding to the ranges of colours offered by different ceramics manufacturers. At present, most manufacturers of ceramics for use in dental prostheses offer one or more discrete ranges of about sixteen subtly different shades. Hitherto, dental prostheses have been made using a single shade or colour of ceramic which has been subjectively judged to be the closest match to a patient's existing tooth or teeth. However, by way of the present invention, it is possible to determine shade variations within a single tooth and to replicate these shade variations in a prosthesis by selecting the closest match from the predetermined range of ceramics colours for individual areas of the tooth, and then to construct a prosthesis by painting or otherwise applying different shades of ceramics to a base prosthesis so as broadly to match the colour variations in the natural tooth. This is a significant advantage over the prior art.

The system of the present invention is of particular advantage in that cross-polarised filtration cuts out, or at least substantially reduces, the glare from the highly reflective surface of a wet enamelled tooth. In this way, an accurate coloured image of a tooth in situ can be obtained. A further advantage of the system resides in the computer programme's ability to break down and analyse colour values from the image of the original tooth and provide colour attributes from which the original colour can be made. This feature advantageously assists the dental laboratory technician in accurately constructing a dental prosthesis to an exact recipe. A yet further advantage of the system is that it reduces human error in subjective colour matching.

According to a further aspect of the invention there is provided a system for identifying colour components of an object comprising:

(i) means for taking a coloured image of an object;

(ii) means for relaying the coloured image to a place, optionally remote from a location where the image of the object was taken;

(iii) means for analysing colour values of the image; and

(iv) means for converting the colour values into parameters so as to compare or record the colour values against a reference set.

Preferably, the system includes any one or more of the features hereinbefore recited.

It will be appreciated that the system of the present invention may be used to take a coloured image of for example and without limitation, a precious metal such as gold and compare this to a standard reference for the colour of a specified purity. The system may also be used to record the individual characteristic colour values of gems such as diamonds. The present system may advantageously be used to facilitate transfer of colour characteristic information and to create reference data.

A yet further use of the colour identification system lies in the security and printing industries, where colour components of currency notes/bonds/securities may be authenticated in addition to photographic identification cards or the like.

According to a further aspect of the invention there is provided a method of colour matching an object comprising the steps of:

(i) capturing a coloured image of the object;

(ii) relaying the captured image to a place remote from the object;

(iii) analysing colour values from the captured image; and

(iv) converting the colour values from the captured image into parameters from which the original colour of the object can be reconstituted.

Preferably, the method further includes the step of illuminating the object with a supply of known light at a specified distance therefrom. For example, this could be by conventional lighting means or by a fibre optic cable suitably positioned with respect to the object. In this way illumination of an object can be standardised and variations that could occur from differing light sources placed at different distances from the object can be reduced.

Preferably, the method further includes the step of reducing/preventing incidental outside light from entering a field of shot. This may be achieved by extending a telescopic tube having two ends so that one end of the tube rests against a surface of the object to be imaged.

Preferably, the method further includes the step of including a reference indicator colour with the captured image. Typically, the reference indicator colour is grey and typically is cool grey C pantone number 8 and thus is of known red, green and blue values. In this way, when the colours of the captured image are analysed, the software program locates the reference colour indicator in the captured image and corrects the red, green and blue values of the whole captured image relative to the reference colour indicator.

Preferably, the method further comprises the step of relaying the colour values back to where the original image was captured so that a comparison can be made between the colour of the original object and that of the reconstituted colour image. This step helps to determine that the correct colour recipe has been achieved. Preferably, a visual display unit (VDU) provided at the place where the image was captured and/or where the captured image is relayed for analysis includes software for correcting the reference colour red, green and blue values on the VDU so that the displayed image on the VDU is colour corrected with respect to the reference colour.

Preferably, the method further comprises the step of committing to memory or storing the generated colour recipe in a central data bank.

Preferably, the method as hereinbefore described is for colour matching a natural tooth or set of teeth with a dental prosthesis.

The method of the present invention is of particular advantage in that, in use, it offers a non-invasive, internal contact-free procedure for obtaining dental information from a patient.

By eliminating the need for placing a camera inside the patient's mouth the present method offers a more hygienic method than the prior art procedures which employ intra-oral cameras and direct contact with the patient's mouth.

Preferably, when taking the image of the patient's natural tooth/teeth in situ, the camera is positioned a predetermined distance from a skeletal reference point on a patient's skull.

Preferably, the camera is positioned in the region of 15-25 cm from the skeletal reference point. The position of the camera from the patient can be monitored by, as hereinbefore described, aligning mutually perpendicular, e.g. horizontal and vertical, cross-hairs or by a common point when right and left light beams/lasers coincide.

Preferably, the skeletal reference point is at the bridge of the patient's nose or nap of his/her chin, the nap being formed at the junction of the lower jaw and bottom set of teeth.

Accordingly, in this application the method comprises the steps of capturing a coloured image of a natural tooth, relaying the captured image to a dental laboratory where a computer program is initiated so as to analyse the colour values of the image of the tooth and to generate a values of intensity of red, green and blue components of the image. A digital image, or contour image, may then be used as a guide by, say, a dental laboratory technician to assist in manufacturing a dental prosthesis by selecting the ceramic shades corresponding to the false-colour representations and then painting these onto a base prosthesis in accordance with the contour map of the third digital image. The dental laboratory technician converts the colour values of the image of the tooth into a recipe from which the original tooth colour can be reconstituted as a dental prosthesis. The dental technician can then compare the dental prosthesis with the original image before releasing the finished article to the dentist for fitting into a patient's mouth.

According to a yet further aspect of the invention there is provided use of the system and/or method as hereinbefore described for the colour matching of textiles, paints, dyes, car body parts, pigments in picture restoration and cosmetics such as hair dyes or skin preparations.

According to a further aspect of the invention there is provided a method of identifying colour parameters of an object comprising the steps of:

(i) capturing a coloured image of the object;

(ii) relaying the captured image to a place, optionally remote from the object;

(iii) analysing colour values from the captured image; and

(iv) converting the colour values from the captured image into parameters so as to compare them to a reference set and/or to record individual characteristic colour values.

Preferably, the method further includes any one or more of the features hereinbefore recited.

It will be appreciated that the method of the present invention may be also be used to monitor colour deterioration over time of, for example, textiles or paintings by comparing colour values against each other over time. Additionally the method may be used to monitor colour standards during industrial processes such as car and/or textile manufacture.

According to a yet further aspect of the invention there is provided use of the system and/or method as hereinbefore described for the colour matching of a natural tooth to a dental prosthesis.

It will be understood that the system may also be used to capture images of a part of a body and to relay this information to a health care professional remote from the patient so that a diagnosis can be made without the patient needing to be physically present. It is envisaged that the system of the present invention may also be used for diagnosing dermatological lesions and other such conditions where the physical appearance and colour of an organ is a relevant diagnostic factor.

According to a yet further aspect of the invention there is provided a dental prosthesis produced by the method of the invention.

According to a yet further aspect of the invention there is provided a method of making a dental prosthesis using the system of the present invention comprising the steps of:

(i) determining shade variations within a tooth;

(ii) replicating the shade variations in a prosthesis by selecting a closest match from a predetermined range of ceramics colours for individual areas of the tooth; and

(iii) constructing a prosthesis by painting or otherwise applying different shades of ceramics to a base prosthesis so as to match the colour variations in the tooth.

### BRIEF DESCRIPTION OF THE DRAWINGS

The invention will now be described by way of example only and with reference to the following Figures wherein:

FIG. 1 represents a schematic flow diagram of the method of colour matching according to the present invention.

FIG. 2 represents a schematic flow diagram of one embodiment of the method of the invention.

FIG. 3 represents a colour analysis of a tooth using the method of the present invention.

FIG. 4 represents a colour reference indicator in situ in a patient's mouth.

### DETAILED DESCRIPTION OF THE INVENTION

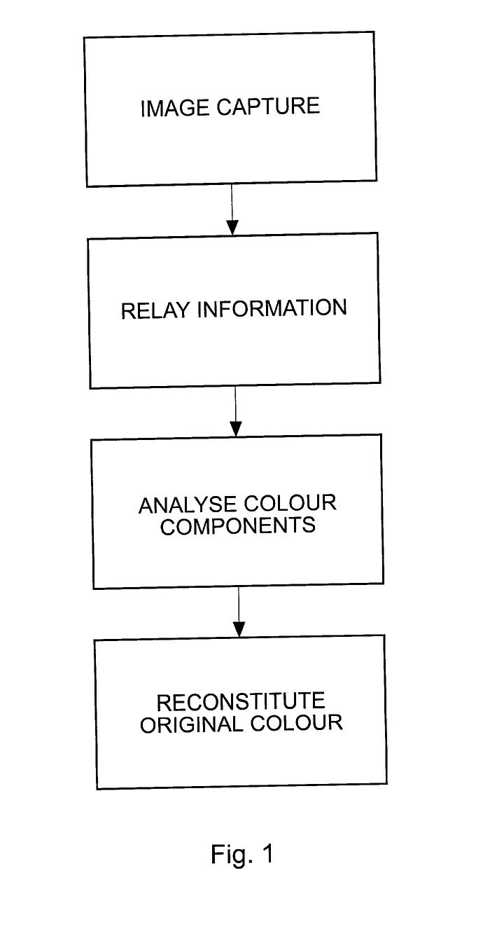

With reference to FIG. 1 there is shown a flow diagram of the steps of the method of colour matching/identification of an object according to the present invention.

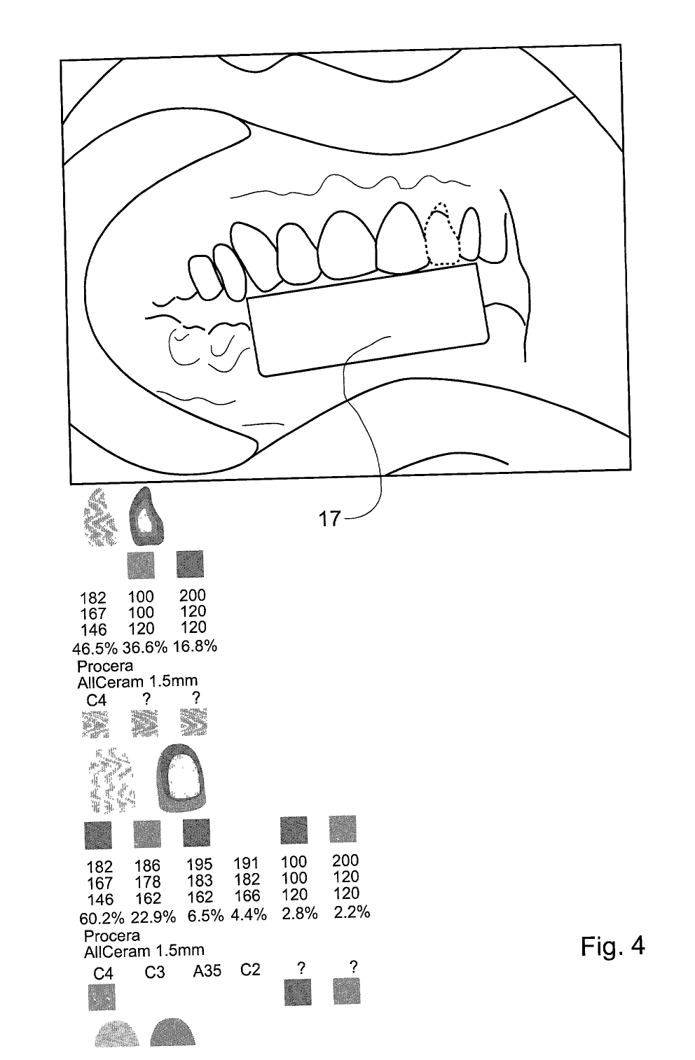

The first step of the method is to capture an image of an object which it is desired to colour match and/or colour identify. This is achieved by first illuminating the object with an appropriate light source and taking at least one photograph of it with a digital camera fitted with cross-polarised filtration. Optionally a colour reference indicator is included in the captured image (see FIG. 4). The camera can be pre-programmed to a specified focal length and arranged to be a selected distance away from the object in order to reduce variations in illumination conditions. The object could be a piece of textile, wall covering, part of a picture which needs to be restored or requires the original colour recorded for posterity, a car body part or a human face for which a suitable cosmetic/hair dye hue can be matched, area of a human body, specimen of currency, photograph, precious metal or gem or any other article which needs to be colour matched/identified.

Once the at least one photograph has been taken, information relating to the colour image can be relayed by an electronic communication system or on a data carrier to a site remote from where the at least one photograph was taken. When this information is received at the appropriate site, an operator initiates a computer program which is capable of interpreting the received data and analysing the colour values of the original image, optionally with respect to the colour reference indicator. Typically the colour values are assigned individual bright colour keys and the analysis proceeds to determine the average and most dominant colour value in each area. The colour values are represented by the intensities of the red, green and blue components of that value. Intensity of red, blue and green is selected as these colours are the primary colours of light. Each image is analysed so that the intensity and relative ratio of each colour is calculated. From the image, colour intensity values are generated so that a replica of the colour of the original coloured object can be produced. The computer program is also capable of converting the values of the red, green and blue intensities into parameters that the operator can reconstitute into colour, for example dye numbers, cosmetic colour values and so on.

The operator can then view the reconstituted image next to the data received for a direct comparison. Alternatively, the operator can transmit the information relating to the reconstituted image to the location of original object so that a comparison can be made between the object itself and the reconstituted image. This step allows for quality control. In the instance of providing a colour reference indicator, the whole image on the VDU/monitor/screen can be colour corrected/calibrated.

It will be appreciated that the method of the present invention provides advantages over the prior art by reducing the level of subjective human assessment of colour matching/identification. Moreover, the method of the present invention can be applied to many diverse industries and can be used to monitor colour quality control in the paint, dye, car and textile industries. It is envisaged that one particular use that will offer improvement over current practices is in colour matching original tooth/teeth colour to a dental prosthesis.

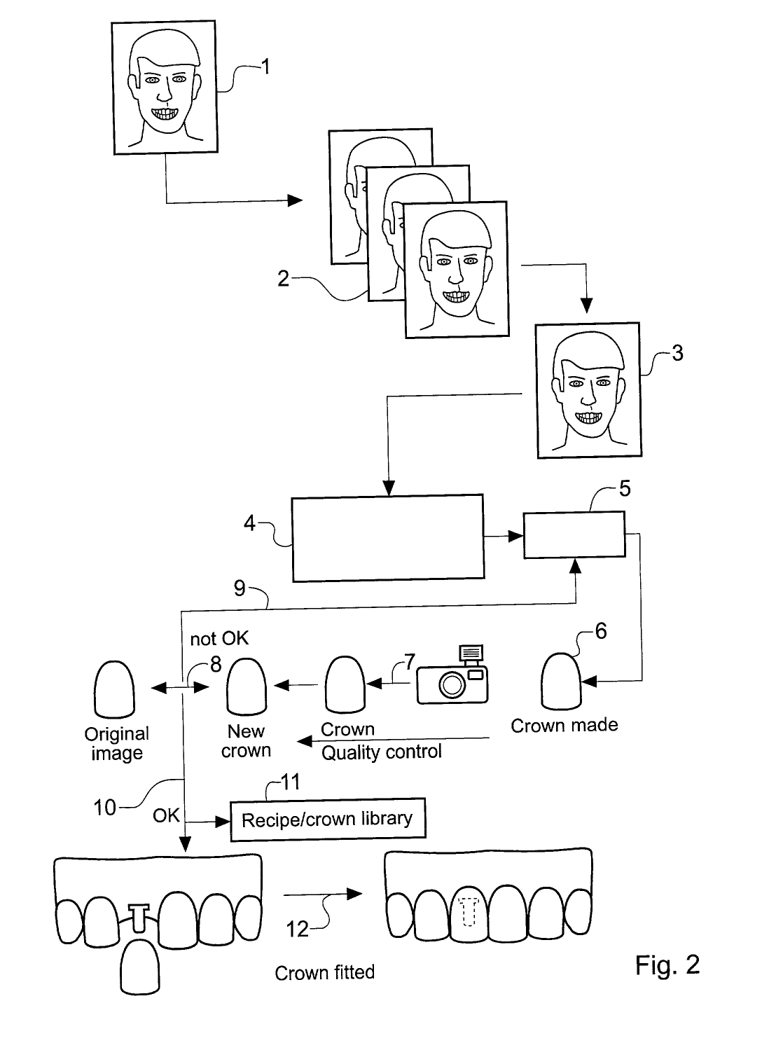

With reference to FIG. 2 there is shown a schematic flow diagram of the method of the present invention when used to colour match a crown. In this process, the first step is to illuminate the patient's mouth in a controlled manner with a known and reproducible light source. The dentist then takes a photograph of the patient's mouth with a digital camera fitted with cross-polarised filtration so as to produce an image (1). The dentist would typically set the camera a pre-determined distance away from the patient with respect to a skeletal reference point such as the bridge of the nose and/or nap of the patient's chin. In this way variations between photographs can be reduced.

Information relating to the colour of the patient's original tooth is downloaded from the digital camera and sent via an electronic communication system such as the Internet or on an electronic data carrier system such as a floppy disc or CD-ROM to the dental laboratory. Since this information is confidential, the information would typically be encrypted for transmission. Once received, the image data is decoded and processed by the computer program so that a series of red, blue and green intensities (2) corresponding to the primary colours of light are produced. The computer program then can calibrate the image with respect to a colour reference indicator into constituent colour values (2) and then into an image (3), and at the same time the program analyses the colour values into relative ratios and distribution patterns so as to generate a colour map. The map can then be converted into dental laboratory parameters such as porcelain colours and so on (4), and the program thereafter provides a recipe (5) from which the dental laboratory technician is able to construct a prosthesis/crown (6).

An image (7) of the prosthesis/crown (6) is then subjected to quality control by comparing its colour to that of the original natural tooth (8). In the instance that there is a discrepancy in the match of colour between the new crown and the original tooth (9) the dental technician can amend the recipe (5) to compensate for the colour difference or alternatively request a further original photograph to work from. In this way, the colour of the crown can advantageously be checked before it is released to the dentist for fitting into a patient's mouth.

In the instance that the crown colour matches the original natural tooth (10), the recipe can be recorded in a central data bank (11) or crown recipe library for future reference. Subsequently, the colour matched crown can be released to the dentist for fitting (12) into the patient's mouth.

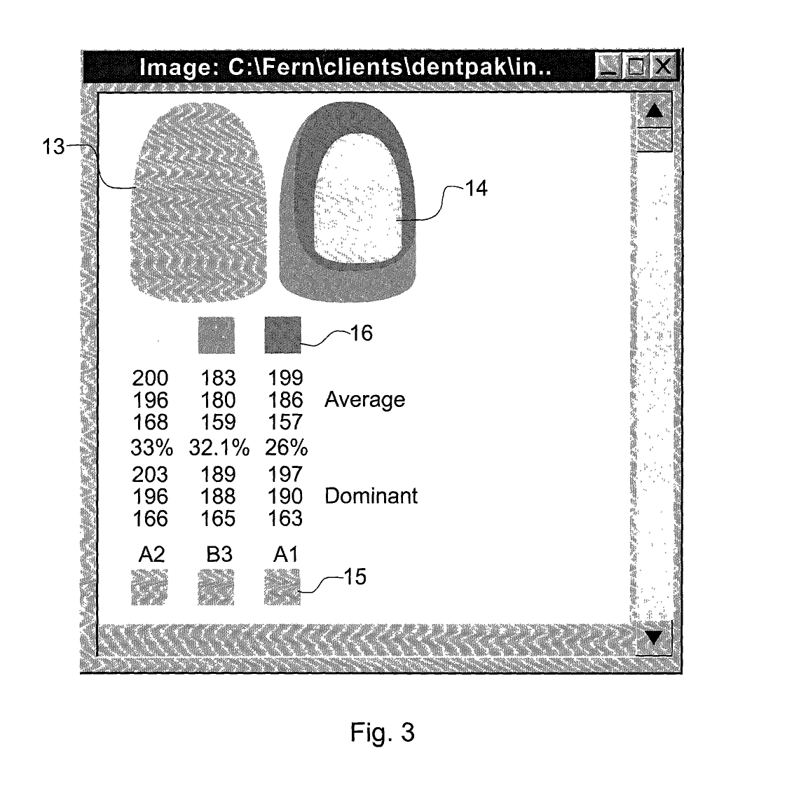

With reference to FIG. 3 there is shown a colour analysis of a tooth using the method of the present invention. The tooth image (13) is divided into several areas of similar colour value, each of which is assigned a unique bright colour key thus making them more distinguishable to the eye as in image (14). The analysis proceeds to determine both the average and the most dominant colour value in each area. The colour values are represented by the intensities of red, green and blue components of that value so that a colour map of the tooth can be visualised. A dental technician may then use image (14) and the keys (15) and (16) to create a dental prosthesis by painting or otherwise applying ceramics materials of the colours shown in key (15) onto a base prosthesis (not shown), using image (14) as a clear contour guide, thus creating a prosthesis matching the image (13).

When, obtaining the image of a tooth the patient may also have placed in his or her mouth a colour reference indicator (FIG. 4 item 17). A typical colour reference indicator is in the form of a block of plastics material, substantially U or L shaped in cross section, to which a patient reference number may be attached or marked. The colour reference indicator is of a suitable size to fit in the patient's mouth without obscuring the tooth to be imaged, whilst still being visible in the image.

The method of the present invention provides improvements over the prior art by reducing the problems associated with construction of a dental prosthesis and helps to avoid the situation where it is found that there is a colour mismatch only when the prosthesis is constructed and returned to the dentist. The present method allows for quality control before release of the prosthesis to the dentist and in this way it is expected that the present method is time efficient and cost effective.

It will also be appreciated that the present invention is of use in diagnosing dermatological lesions and other such conditions where the physical appearance and colour of an organ is a relevant diagnostic factor. The system can be used for capturing images of a part of a body and to relaying this information to a health care professional remote from the patient so that a diagnosis can be made without the patient needing to be physically present.

1. A system for colour matching an object comprising:
(i) means for taking a coloured image of an object;
(ii) means for relaying the coloured image to a place remote from a location where the image of the object was taken;
(iii) means for analysing colour values of the image; and
(iv) means for converting the colour values into parameters from which the original colour of the object can be reconstituted.

2. A system according to claim 1 wherein the means for taking a coloured image of the object is a camera.

3. A system according to claim 2 wherein the means for taking a coloured image of the object is a digital camera.

4. A system according to either claim 2 or 3 wherein the camera is provided with cross-polarised filtration so as to produce a cross-polarised image.

5. A system according to any one of claims 2-4 wherein the camera is pre-set and/or pre-programmed to a specified focal length.

6. A system according to claim 5 wherein the focal length is 25±2 cm.

7. A system according to any preceding claim further including a camera housing assembly for supporting the camera.

8. A system according to claim 7 wherein the camera housing assembly is provided with a light source for illuminating the object.

9. A system according to claim 8 wherein light is transmitted to the camera housing assembly via a fibre optic cable.

10. A system according to either claim 8 or 9 wherein the light source comprises a plurality of light spots.

11. A system according to claim 10 wherein the light spots are arranged in a ring.

12. A system according to any one of claims 7 to 11 wherein the camera housing assembly further comprises a telescopic member for preventing incidental light entering an image field of shot.

13. A system according to claim 12 wherein the telescopic member comprises a tube comprising two independently extendible longitudinal tube halves whose longitudinal edges slidingly engage and which may be adjusted so that, in use, and when extended, the tube can be made to approximately conform to the shape of curved objects and to rest thereagainst by extending one half of the tube more than the other half.

14. A system according to either claim 12 or 13 wherein the telescopic member, in use, is extended prior to taking an image and is retracted when not in use.

15. A system according to any one of claims 7 to 14 wherein the camera housing assembly further comprises means for assessing distance between the camera and the object to be imaged.

16. A system according to claim 15 wherein the means for assessing distance comprises a mutually perpendicular cross-hair arrangement.

17. A system according to claim 15 wherein the means for assessing distance comprises a pair of right and left light beams or lasers.

18. A system according to any preceding claim further including a reference colour indicator placed in close proximity to the object or associated with the means for taking a coloured image of an object so that the captured image contains a reference colour.

19. A system according to claim 18 wherein the reference colour is grey.

20. A system according to claim 19 wherein the grey is cool grey C pantone number 8.

21. A system according to any one of claims 18 to 20 wherein the reference colour indicator comprises a substantially U or L shaped block or a sheet or paper.

22. A system according to any preceding claim wherein the means for relaying the captured image to a place remote from a location where the image was captured is an electronic communication means.

23. A system according to claim 22 wherein the electronic communication means is an Internet connection, a dedicated telephone line or a data carrier.

24. A system according to claim 23 wherein in the instance of relaying image data via the Internet data is encrypted so that whilst it is in the public domain or “on air” it is in a form that cannot be accessed by the public.

25. A system according to claim 4 or any claim depending therefrom, wherein the means for analysing the colour values is a computer software program which is capable of converting the cross-polarised image of the original object into a plurality of colour components.

26. A system according to any preceding claim wherein the colour values of the captured image of the original object colour are represented by intensities of red, blue and green colour components.

27. A system according to any preceding claim when used in colour matching a natural tooth or set of teeth so that a dental prosthesis can be constructed to match the natural tooth of a patient.

28. A system for identifying colour components of an object comprising:
(i) means for taking a coloured image of an object;
(ii) means for relaying the coloured image to a place, optionally remote from a location where the image of the object was taken;
(iii) means for analysing colour values of the image; and
(iv) means for converting the colour values into parameters so as to compare or record the colour values against a reference set.

29. A system according to claim 28 further including any one or more of the features recited in claims 2 to 26.

30. A method of colour matching an object comprising the steps of:
(i) capturing a coloured image of the object;
(ii) relaying the captured image to a place remote from the object;
(iii) analysing colour values from the captured image; and
(iv) converting the colour values from the captured image into parameters from which the original colour of the object can be reconstituted.

31. A method according to claim 30 wherein the object is illuminated with a supply of known light at a specified distance therefrom prior to step (i).

32. A method according to either claim 30 or 31 further including the step of reducing/preventing incidental light from entering a field of shot.

33. A method according to any one of claims 30 to 32 further including the step of including a reference colour indicator with the captured image.

34. A method according to claim 33 wherein the reference colour indicator is of known red, green and blue values, so that when the colours of the captured image are analysed, the reference colour is located in the captured image and red, green and blue values of the whole captured image are corrected relative to the reference colour.

35. A method according to any one of claims 30 to 34 further including the step of relaying the colour values back to a location where the original image was captured so that a comparison can be made between the colour of the original object and that of the reconstituted colour image.

36. A method according to any one of claims 30 to 35 wherein a VDU is provided at the place where the image was captured and/or where the captured image is relayed for analysis is provided with software for correcting reference colour red, green and blue values on the monitor/screen so that a displayed image on the VDU is colour corrected with respect to the reference colour.

37. A method according to any one of claims 30 to 36 further including the step of committing to memory or storing a colour recipe in a central data bank.

38. A method according to any one of claims 30 to 37 further including any one or more of the features recited in claims 2 to 26.

39. A method according to any one of claims 30 to 38 when used in colour matching a natural tooth or set of teeth with a dental prosthesis.

40. A method according to claim 39 wherein when taking the image of a patient's natural tooth/teeth in situ, the camera is positioned a predetermined distance from a skeletal reference point on a patient's skull.

41. A method according to claim 40 wherein the camera is positioned from 15-25 cm inclusive from the skeletal reference point.

42. A method according to either claim 40 or 41 wherein the skeletal reference point is at the bridge of the patient's nose or nap of his/her chin, the nap being formed at the junction of the lower jaw and bottom set of teeth.

43. A method according to any one of claims 39 to 42 wherein the camera position with respect to the patient is monitored by aligning horizontal and vertical cross hairs or by a common point when left and right light beams or lasers coincide.

44. A method of identifying colour parameters of an object comprising the steps of:
(i) capturing a coloured image of the object;
(ii) relaying the captured image to a place, optionally remote from the object;
(iii) analysing colour values from the captured image; and
(iv) converting the colour values from the captured image into parameters so as to compare them to a reference set and/or to record individual characteristic colour values.

45. A method according to claim 44 further including any one or more of the features recited in claims 31 to 38.

46. Use of the system according to any one of claims 1 to 26 when used for colour matching of textiles, paints, dyes, car body parts, cosmetics, hair dyes, skin preparations and pigments in picture restoration.

47. Use of the system according to any one of claims 28 to 30 when used to identify colour parameters of precious metals, gems and stones, currency notes, identity pictures/photographs and batch colouring processes.

48. Use of the method according to any one of claims 30 to 38 when used for colour matching of textiles, paints, dyes, car body parts, pigments in picture restoration and cosmetics.

49. Use of the method according to either claim 44 or 45 when used for identifying colour parameters of metals, gems and stones, currency notes, identity pictures/photographs and batch colouring processes.

50. Use of the system according to any one of claims 1 to 27 when used for the colour matching of a natural tooth to a dental prosthesis.

51. Use of the method according to any one of claims 30 to 43 when used for the colour matching of a natural tooth to a dental prosthesis.

52. Use of a system according to any one of claims 1 to 26 when used for capturing images of a part of a body and relaying this information to a health care professional remote from a patient so that a diagnosis can be made without the patient needing to be physically present.

53. Use of a method according to any one of claims 30 to 43 when used for capturing images of a part of a body and relaying this information to a health care professional remote from a patient so that a diagnosis can be made without the patient needing to be physically present.

54. Use of a system and/or method according to either of claims 52 or 53 when used for diagnosing dermatological lesions and other such conditions where the physical appearance and colour of an organ is a relevant diagnostic factor.

55. A dental prosthesis product produced by the method according to any one of claims 30 to 43

56. A method of making a dental prosthesis using the system according to any one of claims 1 to 26 comprising the steps of:
(iv) determining shade variations within a tooth;
(v) replicating the shade variations in a prosthesis by selecting a match from a predetermined range of ceramics colours for individual areas of the tooth; and
(vi) constructing a prosthesis by painting or otherwise applying different shades of ceramics to a base prosthesis so as to match the colour variations in the tooth.
